(19) United States
(12) Patent Application Publication
(10) Pub. No.: US 2008/0179204 A1
(43) Pub. Date: Jul. 31, 2008

(54) Container of Smokable Articles Sealed with a Label

(75) Inventor: Bodo W. Lutzig, Chavornay (CH)

Correspondence Address: BUCHANAN, INGERSOLL & ROONEY PC, POST OFFICE BOX 1404, ALEXANDRIA, VA, 22313-1404, US

(73) Assignee: PHILIP MORRIS PRODUCTS S.A., Neuchatel (CH)

(21) Appl. No.: 11/794,236

(22) PCT Filed: Dec. 28, 2004
(86) PCT No.: PCT/EP04/53715

§ 371 Date: Aug. 30, 2007

(51) Int. Cl. B42D 15/10; B65D 85/10

(52) U.S. Cl. 206/247; 283/107; 206/274

(57) ABSTRACT

A container of smokable articles, preferably cigarettes, and a label, preferably a tax label or sticker. The label is made of a transparent, partially printed plastic sheet. The label is used to seal the container, preferably a display carton or a cigarette pack. A method of sealing a container of smokable articles comprises applying a label comprising a partially printed, transparent plastic sheet over at least a portion of a top face of the container.

The invention relates to a container of smokable articles having a label applied thereto and in particular to a pack of cigarettes sealed with a tax sticker or tax label.

Smokable articles such as cigarettes, cigarillos, or cigars are usually sold in rigid, semi rigid or soft packs. To indicate that the required tax has been paid for the smokable articles, such packs are often sealed with a tax label. Known tax labels for packs of smokable articles are made of paper or plastic material on which the required tax information is printed, both materials being substantially impermeable to light. Usually, the pack of smokable articles including the attached tax label is over wrapped with a transparent film. During the over wrapping process, certain areas of the transparent film are sealed together by the application of heat in, for example, a shrink tunnel.

For rigid packs of smokable articles, such as hinge-lid packs, the tax label usually extends from the front face of the pack over the top face of the pack to the rear face of the pack, thereby covering a substantial portion of the total surface area of the pack. For soft packs of smokable articles, the tax label usually covers a portion of the top face of the pack. In some cases, display cartons containing a number of hard or soft packs of smokable articles are also sealed with a tax label and/or have other labels applied to the surface thereof.

Since the surface of a pack of smokable articles is frequently used to carry important consumer information, and the tax label covers part of that surface, it is desirable for the size of the tax label to be kept as small as possible. A certain minimum size of tax label is, however, required in order to seal the pack such that it cannot be opened without breaking the tax label. A need, therefore, exists in the smokable article packaging industry to reduce the surface area of a pack of smokable articles concealed by a tax label, while at the same time ensuring that the pack cannot be opened without breaking the tax label.

Accordingly, it is an object of the present invention to provide a pack of smokable articles that, although sealed with a tax label, has a substantially increased proportion of its surface visible to the consumer compared to known sealed packs.

This object is achieved by a container of smokable articles having a label applied thereto, the label sealing the container such that the consumer has to break the label to gain access to the contents of the container, characterized in that the label comprises a partially printed, transparent plastic sheet.

The container may be an individual pack comprising a plurality of smokable articles, preferably a soft or a hard pack, or a display carton comprising a plurality of individual packs comprising a plurality of smokable articles. In particular, the container of the present invention may be a cigarette pack, or a display carton comprising a plurality of cigarette packs.

Smokable articles under the definitions of the present invention include but are not limited to cigarettes, cigarillos, cigars, and tobacco cartridges.

The entire label may be between about 30 mm and about 50 mm long, and between about 10 mm to about 30 mm wide. A preferred label is about 42 mm long and about 20 mm wide. However, depending on the specific requirements of the container, other dimensions are also possible, for example, equilateral labels having a length and width of between about 15 mm and about 30 mm may be employed.

The printed area of the label may cover between about 30% and about 70%, preferably between about 40% and about 60%, and most preferably about 50% of the surface of the entire label. The printed area of a preferred label is about 20 mm wide and about 21 mm long. However, depending on the specific requirements of the container other values are also possible, for example, for the above-mentioned equilateral labels, the printed area of the label may cover up to 90% of the surface of the entire tax sticker or tax label.

Where the label is not equilateral, the printed area is preferably located in the longitudinal center of the label. However, it may be desirable that the printed area is located close to an edge of the label.

The surface of the container of the invention underneath unprinted areas of the label is visible through the transparent plastic sheet. The transparency of the plastic sheet of the label, therefore, advantageously results in an increased proportion of the total surface area of the container of the invention being visible to the consumer compared to known packs of smoking articles having tax labels affixed thereto.

Preferably, all printed matter on the label is located on the top or upper surface of the label, that is the surface of the label that is not in contact with the container. A particular advantage of this embodiment is that there is no risk that colors used to print the label will adhere to the container surface, and so potentially damage the container surface upon breaking of the label. However, a small amount of printed matter, such as, for example, eye-marks or other marks helpful during the production process of the label, may be located on the bottom or lower surface of the label, that is the surface of the label which is in contact with the container. Preferably at least one surface of the label is coated with an acrylic coating agent, preferably with an aqueous acrylic dispersion, more preferably with a chlorine-free aqueous acrylic dispersion. Where the container is over wrapped with a transparent film, the coating agent advantageously avoids sealing of the film to the label during the over wrapping process.

For easy machining, an eye-mark may be printed underneath the tax information or other printed matter applied to the label or on the surface of the label opposite the surface to which the tax information or other printed matter is applied. The eye-mark is preferably of a contrast color such as for example black or white, and is preferably of a machine recognizable rectangular shape, preferably between about 10 mm and about 15 mm wide, and between about 1 mm and about 5 mm long. A particularly preferred eye-mark is about 13 mm wide and about 4 mm long. The eye-mark is preferably located in the geometrical center of the printed area of the label. Since tax labels for packs of smokable articles are usually produced on a reel containing several hundreds to thousands of meters of plastic sheet, the individual labels are obtained by cutting the reel into pieces of the required length. The eye-mark helps the cutting tool to determine the exact dimensions, that is the exact length of an individual tax label, by optical inspection and, thus, to place the cuts accordingly. Labels for containers according to the present invention may also be produced on flat transparent plastic sheets rather than on reels.

The label of the container of the present invention may comprise any transparent plastic sheet including, but not limited to, polyester, polypropylene and polyethylene. Preferably, the plastic sheet is selected from polypropylene, polyethylene and in particular, biaxially oriented polypropylene. The plastic sheet preferably has a thickness of between about 10 μm to about 100 μm, more preferably of between about 20 μm to about 60 μm. Preferably, the plastic sheet of the label is coated on at least one side with an adhesive, self-adhesive and/or heat-sealable agent, and at least one side of the plastic sheet is receptive to inks, adhesives or tear-tapes. It is particularly preferred, if a substantially unprinted surface of the label is coated with an adhesive, self adhesive and/or heat-sealable agent, to allow the label to be adhered to the container, and the other surface of the label is receptive to inks. In particular, it is preferred if one side of the label is coated with a heat-sealable agent and the other side is not.

Where the plastic sheet is coated with an adhesive, self-adhesive and/or heat-sealable agent, preferably the adhesive, self-adhesive and/or heat-sealable agent are/is transparent.

Transparency within the definitions of the present invention means that the container surface appears through the unprinted area of the plastic sheet in substantially the same manner as if no plastic sheet was present. Thus, substantially no difference exists for the viewer between the area of the container surface that is covered by the transparent part of the label and the uncovered areas of the container surface directly adjacent to the label. In other words, the coefficient I/I₀ with I₀ being the intensity of light in the visible spectrum before transmittal through the plastic sheet and I being the intensity of light after transmittal through the plastic sheet is as close as possible to the ideal value of 1. Preferably, the coefficient I/I₀ is between 0.8 and 1, more preferably between 0.9 and 1.

Where the container is, for example, a hard pack of cigarettes, the label preferably extends from a front face of the container over a top face of the container to a rear face of the container or, alternatively, for a hinge-lid pack from a rear face to a side face of the container at the same time extending over the contact area of lid and box part on the side face. These two embodiments ensure that opening of the pack is impossible without breaking the label. Hard packs of cigarettes often have a hinged lid, the opening or lid line extending across the front face of the pack. Where such hinged lid packs are provided with a tax label or sticker, the tax information itself can be placed on the top face of the pack and the tax label needs to cover the opening line of the hinged lid on the front face or the side face of the pack. Soft packs of cigarettes are opened on their top face. Accordingly, where the container of the invention is, for example, a soft pack of cigarettes the label only needs to cover a portion of the top face of the pack. In this case, the label may be affixed to at least a portion of the top face of the container itself and/or to, for example, the top face of a metallized paper inner liner in which a bundle of cigarettes held within the container is wrapped

The present invention further relates to the use of a label comprising a partially printed, transparent plastic sheet to seal a container of smokable articles.

The present invention also relates to a method of sealing a container of smokable articles comprising applying a label comprising a partially printed, transparent plastic sheet over at least a portion of a top face of the container. Preferably, the method comprises applying a label coated on one side with a heat-sealable agent and coated on the other side with an acrylic coating agent to the container. Preferably, the acrylic coated side of the label is printed with tax or other information and the side coated with the heat-sealable agent is placed in contact with the container. This allows for tight adhering of the label to the container and at the same time, where the container is over wrapped with a transparent film, avoids sealing of the label to the film.

The container according to the invention can be produced either manually by placing the subject tax label onto the container and fixing it thereto by, e.g., applying heat, or automatically on, e.g., high-speed cigarette pack makers where the subject labels are cut from the above-described reels, placed onto the subject containers and fixed thereto by, e.g., applying heat.

1. A container of smokable articles having a label, preferably a tax label, applied thereto, the label sealing the container such that the consumer has to break the label to gain access to the contents of the container, characterized in that the label comprises a partially printed, transparent plastic sheet.

2. A container according to claim 1 wherein the container is a pack of cigarettes.

3. A container according to claim 1 wherein the container is a display carbon comprising a plurality of individual packs of cigarettes.

4. A container according to claim 1 wherein substantially all printed matter on the label is located on the upper surface of the label.

5. A container according to claim 1 wherein at least one surface of the label is coated with an acrylic coating agent, preferably with an aqueous acrylic dispersion, more preferably with a chlorine-free aqueous acrylic dispersion.

6. A container according to claim 1 wherein an eye-mark is printed underneath a printed area on the upper surface of the label or on the lower surface of the label opposite a printed area on the upper surface of the label.

7. A container according to claim 1 wherein the plastic sheet is made from polyolefin material, preferably polypropylene, polyethylene and biaxially oriented polypropylene.

8. A container according to claim 1 wherein the plastic sheet is coated on at least one side with an adhesive, self-adhesive and/or heat-sealable agent and is receptive on at least one side to inks, adhesives or tear-tapes.

9. A container according to claim 8, wherein the adhesive self-adhesive and/or heat-sealable agent are/is transparent.

10. A container according to claim 1 wherein the label extends over at least a portion of a top face of the container.

11. A container according to claim 1 wherein the label extends from a front face of the container over a top face of the container to a rear face of the container.

12. Use of a label comprising a partially printed, transparent plastic sheet to seal a container of smokable articles.

13. A method of sealing a container of smokable articles comprising applying a label comprising a partially printed, transparent plastic sheet over at least a portion of a top face of the container.
